(19) United States
(12) Patent Application Publication
(10) Pub. No.: US 2026/0292831 A1
(43) Pub. Date: Sep. 24, 2026

(54) UPLINK TRANSMISSIONS IN CELLULAR COMMUNICATION NETWORKS USING MULTIPLE ANTENNA ARRANGEMENTS

(71) Applicant: Nokia Technologies Oy, Espoo (FI)

(72) Inventors: Sami-Jukka HAKOLA, Oulu (FI); Juha Pekka KARJALAINEN, Oulu (FI); Timo KOSKELA, Oulu (FI); Mihai ENESCU, Espoo (FI)

(21) Appl. No.: 19/473,673

(22) PCT Filed: Mar. 20, 2024
(86) PCT No.: PCT/EP2024/057446

§ 371 Date: Oct. 8, 2025

(30) Foreign Application Priority Data
Apr. 14, 2023 (FI) 20235430

(51) Int. Cl. H04W 72/21; H04B 7/06

(52) U.S. Cl. CPC H04W 72/21; H04B 7/0639

(57) ABSTRACT

According to an example aspect of the present invention, there is provided a method comprising receiving by a user equipment, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, deriving by the user equipment, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, determining by the user equipment a first uplink transmission parameter based on the first maximum rank value, and a second uplink transmission parameter based on the second maximum rank value and performing by the user equipment the uplink transmission via a first antenna arrangement of the user equipment based at least in part on the first uplink transmission parameter, and via a second antenna arrangement of the user equipment based at least in part on the second uplink transmission parameter.

### FIELD

Various example embodiments relate in general to cellular communication networks and more specifically, to uplink transmissions using multiple antenna arrangements in such networks.

### BACKGROUND

Uplink transmissions using multiple antenna arrangements may be used to enhance operation of wireless communication systems. Uplink transmissions using multiple antenna arrangements may be used for example in various cellular communication networks, such as in cellular communication networks operating according to 5G radio access technology. 5G radio access technology may also be referred to as New Radio, NR, access technology. 3rd Generation Partnership Project, 3GPP, develops standards for 5G/NR and one of the topics in the 3GPP discussions is related to using multiple antenna arrangements for uplink transmissions. According to the discussions there is a need to provide enhanced methods, apparatuses and computer programs related to multiple antenna arrangements for uplink transmissions in cellular communication networks. Such enhancements may also be beneficial in other wireless communication networks, such as in 6G networks in the future, as well.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect of the present invention, there is provided an apparatus comprising at least one processing core, at least one processor; and at least one memory storing instructions that, when executed by the at least one processor, cause the apparatus at least to receive, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, determine a first uplink transmission parameter based on the first maximum rank value, and a second uplink transmission parameter based on the second maximum rank value and perform the uplink transmission via a first antenna arrangement of the apparatus based at least in part on the first uplink transmission parameter, and via a second antenna arrangement of the apparatus based at least in part on the second uplink transmission parameter.

Example embodiments of the first aspect may comprise at least one feature from the following bulleted list or any combination of the following features:
wherein the first and second uplink transmission parameters are transmit precoder matrices;
wherein the control information further comprises a first Transmit Precoder Matrix Identifier, TMPI, associated with the first indicated uplink reference signal resource, and a second TPMI associated with the second indicated uplink reference signal resource;
wherein the stored instructions further cause, when executed by the at least one processor, the apparatus at least to transmit, to the wireless network node, first capability information indicative of a first maximum number of antenna ports supported by the first antenna arrangement, of a second maximum number of antenna ports supported by the second antenna arrangement, and of a total maximum number of antenna ports supported by the apparatus;
wherein the first maximum number of antenna ports is lower than or equal to the total maximum number of antenna ports, and the second maximum number of antenna ports is lower than or equal to the total maximum number of antenna ports;
wherein the stored instructions further cause, when executed by the at least one processor, the apparatus at least to transmit, to the wireless network node, second capability information indicative of supported antenna port combinations across the first and second antenna arrangements, wherein the supported antenna port combinations individually comprise a first number of antenna ports for the first antenna arrangement lower than or equal to the first maximum number of antenna ports, and a second number of antenna ports for the second antenna arrangement lower than or equal to the second maximum number of antenna ports, and a sum of the first and second number of antenna ports is lower than or equal to the total maximum number of antenna ports;
wherein the first and second antenna arrangements are associated with respective capability indexes;
wherein the stored instructions further cause, when executed by the at least one processor, the apparatus at least to receive, from the wireless network node, configuration information indicative of a first resource set comprising first configured uplink reference signal resources, and of a second resource set comprising second configured uplink reference signal resources;
wherein the first configured uplink reference signal resources individually comprise a first number of antenna ports lower than or equal to a first maximum number of antenna ports supported by the first antenna arrangement, and the second configured uplink reference signal resources individually comprise a second number of antenna ports lower than or equal to a second maximum number of antenna ports supported by the second antenna arrangement;
wherein a sum of a first number of antenna ports of a first configured uplink reference signal resource of the first resource set and of a second number of antenna ports of a second configured uplink reference signal resource of the second resource set is strictly greater than a total maximum number of antenna ports supported by the apparatus;
wherein the first configured uplink reference signal resource of the first resource set is restricted to be time-multiplexed with the second configured uplink reference signal resource of the second resource set;
wherein a first configured uplink reference signal resource of the first resource set is spatially-multiplexed or frequency-multiplexed or time-multiplexed with a second configured uplink reference signal resource of the second resource set if a sum of a first number of antenna ports of the first configured uplink reference signal resource and of a second number of antenna ports of the second configured uplink reference signal resource is lower than or equal to a total maximum number of antenna ports supported by the apparatus;
wherein the first and second configured uplink reference signal resources are Sounding Reference Signal, SRS, resources, and the first and second resource sets are SRS resource sets.

According to a second aspect of the present invention, there is provided an apparatus comprising at least one processing core, at least one processor; and at least one memory storing instructions that, when executed by the at least one processor, cause the apparatus at least to transmit, to a user equipment, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, determine a first uplink transmission parameter based on the first maximum rank value, and a second uplink transmission parameter based on the second maximum rank value and receive the uplink transmission via a first antenna arrangement of the user equipment based at least in part on the first uplink transmission parameter, and via a second antenna arrangement of the user equipment based at least in part on the second uplink transmission parameter.

Example embodiments of the second aspect may comprise at least one feature from the following bulleted list or any combination of the following features:
wherein the first and second uplink transmission parameters are transmit precoder matrices;
wherein the control information further comprises a first Transmit Precoder Matrix Identifier, TMPI, associated with the first indicated uplink reference signal resource, and a second TPMI associated with the second indicated uplink reference signal resource;
wherein the stored instructions further cause, when executed by the at least one processor, the apparatus at least to receive, from the user equipment, first capability information indicative of a first maximum number of antenna ports supported by the first antenna arrangement, of a second maximum number of antenna ports supported by the second antenna arrangement, and of a total maximum number of antenna ports supported by the user equipment;
wherein the first maximum number of antenna ports is lower than or equal to the total maximum number of antenna ports, and the second maximum number of antenna ports is lower than or equal to the total maximum number of antenna ports;
wherein the stored instructions further cause, when executed by the at least one processor, the apparatus at least to receive, from the user equipment, second capability information indicative of supported antenna port combinations across the first and second antenna arrangements, wherein the supported antenna port combinations individually comprise a first number of antenna ports for the first antenna arrangement lower than or equal to the first maximum number of antenna ports, and a second number of antenna ports for the second antenna arrangement lower than or equal to the second maximum number of antenna ports, and a sum of the first and second number of antenna ports is lower than or equal to the total maximum number of antenna ports;
wherein the first and second antenna arrangements are associated with respective capability indexes;
wherein the stored instructions further cause, when executed by the at least one processor, the apparatus at least to transmit, to the user equipment, configuration information indicative of a first resource set comprising first configured uplink reference signal resources, and of a second resource set comprising second configured uplink reference signal resources;
wherein the first configured uplink reference signal resources individually comprise a first number of antenna ports lower than or equal to a first maximum number of antenna ports supported by the first antenna arrangement, and the second configured uplink reference signal resources individually comprise a second number of antenna ports lower than or equal to a second maximum number of antenna ports supported by the second antenna arrangement;
wherein a sum of a first number of antenna ports of a first configured uplink reference signal resource of the first resource set and of a second number of antenna ports of a second configured uplink reference signal resource of the second resource set is strictly greater than a total maximum number of antenna ports supported by the user equipment;
wherein the first configured uplink reference signal resource of the first resource set is restricted to be time-multiplexed with the second configured uplink reference signal resource of the second resource set;
wherein a first configured uplink reference signal resource of the first resource set is spatially-multiplexed or frequency-multiplexed or time-multiplexed with a second configured uplink reference signal resource of the second resource set if a sum of a first number of antenna ports of the first configured uplink reference signal resource and of a second number of antenna ports of the second configured uplink reference signal resource is lower than or equal to a total maximum number of antenna ports supported by the user equipment;
wherein the first and second configured uplink reference signal resources are Sounding Reference Signal, SRS, resources, and the first and second resource sets are SRS resource sets.

According to a third aspect of the present invention, there is provided a method, comprising receiving by a user equipment, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, deriving by the user equipment, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, determining by the user equipment a first uplink transmission parameter based on the first maximum rank value, and a second uplink transmission parameter based on the second maximum rank value and performing by the user equipment the uplink transmission via a first antenna arrangement of the user equipment based at least in part on the first uplink transmission parameter, and via a second antenna arrangement of the user equipment based at least in part on the second uplink transmission parameter.

According to a fourth aspect of the present invention, there is provided a method, comprising transmitting by an apparatus, to a user equipment, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, deriving by the apparatus, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, determining, by the apparatus, a first uplink transmission parameter based on the first maximum rank value, and a second uplink transmission parameter based on the second maximum rank value and receiving, by the apparatus, the uplink transmission via a first antenna arrangement of the user equipment based at least in part on the first uplink transmission parameter, and via a second antenna arrangement of the user equipment based at least in part on the second uplink transmission parameter.

According to a fifth aspect of the present invention, there is provided an apparatus, comprising means for receiving, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, means for deriving based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, means for determining a first uplink transmission parameter based on the first maximum rank value, and a second uplink transmission parameter based on the second maximum rank value and means for performing uplink transmission via a first antenna arrangement of the apparatus based at least in part on the first uplink transmission parameter, and via a second antenna arrangement of the apparatus based at least in part on the second uplink transmission parameter.

According to a sixth aspect of the present invention, there is provided an apparatus, comprising means for transmitting, to a user equipment, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set, means for deriving, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource, means for determining a first uplink transmission parameter based on the first maximum rank value, and a second uplink transmission parameter based on the second maximum rank value and means for receiving, by the apparatus, the uplink transmission via a first antenna arrangement of the user equipment based at least in part on the first uplink transmission parameter, and via a second antenna arrangement of the user equipment based at least in part on the second uplink transmission parameter.

According to a seventh aspect of the present invention, there is provided a non-transitory computer readable medium having stored thereon a set of computer readable instructions that, when executed by at least one processor, cause an apparatus to at least perform the first method. According to an eighth aspect of the present invention, there is provided a non-transitory computer readable medium having stored thereon a set of computer readable instructions that, when executed by at least one processor, cause an apparatus to at least perform the second method.

According to a ninth aspect of the present invention, there is provided a computer program comprising instructions which, when the program is executed by an apparatus, cause the apparatus to carry out the first method. According to a tenth aspect of the present invention, there is provided a computer program comprising instructions which, when the program is executed by an apparatus, cause the apparatus to carry out the second method.

### BRIEF DESCRIPTION OF THE DRAWINGS

FIG. 1 illustrates an example of a network scenario in accordance with at least some example embodiments;

FIG. 2a illustrates an example of a two-panel antenna arrangement with 4 port {3+1} transmission in accordance with at least some example embodiments;

FIG. 2b illustrates an example of a two-panel antenna arrangement with 4 port {4+0} transmission in accordance with at least some example embodiments;

FIG. 2c illustrates an example of a two-panel antenna arrangement with 4 port {0+4} transmission in accordance with at least some example embodiments;

FIG. 2d illustrates an example of a two-panel antenna arrangement with 4 port {2+2} transmission in accordance with at least some example embodiments;

FIG. 2e illustrates an example of a two-panel antenna arrangement with 4 port {2+2} transmission in accordance with at least some example embodiments;

FIG. 2f illustrates an example of a two-panel antenna arrangement with 4 port {1+3} transmission in accordance with at least some example embodiments;

FIG. 3 illustrates an example of possible multiplexing options in accordance with at least some example embodiments;

FIG. 4 illustrates a signalling graph in accordance with at least some example embodiments;

FIG. 5 illustrates an example apparatus capable of supporting at least some example embodiments;

FIG. 6 illustrates a flow graph of a method in accordance with at least some example embodiments.

### EXAMPLE EMBODIMENTS

Embodiments of the present disclosure provide improvements for uplink transmissions using multiple antenna arrangements in cellular communication networks. More specifically, embodiments of the present disclosure enable the use of a flexible architecture for a User Equipment, UE, comprising at least two antenna arrangements. Antenna ports of the at least two antenna arrangements may be shared in a flexible manner and hence, the number of antenna ports to be used for uplink transmissions may be different for different antenna arrangements of the UE. The antenna arrangements may be physical or logical antenna arrangements. Furthermore, antenna ports can be associated with any data channel (e.g., Physical Uplink Shared Channel, PUSCH) or control channel (e.g., Physical Uplink Control Channel, PUCCH) or reference signals (e.g., uplink Sounding Reference Signal, SRS).

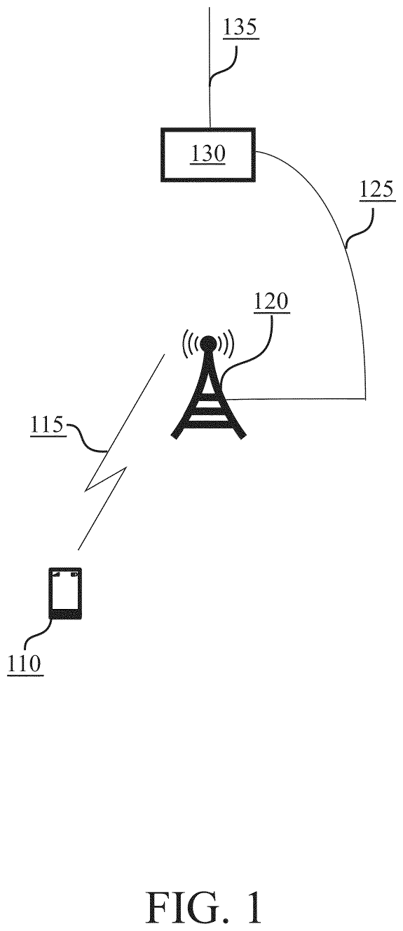

FIG. 1 illustrates an example of a network scenario in accordance with at least some example embodiments. According to the example scenario of FIG. 1, there may be a communication system, which comprises UE 110, wireless network node 120 and core network element 130. UE 110 may be connected to wireless network node 120 via air interface 115. UE 110 may be connected to wireless network node 120, e.g., by using multiple beams, either simultaneously or one at a time. That is, air interface 115 may be a beam-based air interface.

UE 110 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal. Wireless network node 120 may be considered as a serving node for UE 110 and one cell of wireless network node 120 may be a serving cell for UE 110.

Air interface between UE 110 and wireless network node 120 may be configured in accordance with a Radio Access Technology, RAT, which both UE 110 and wireless network node 120 are configured to support. Examples of cellular RATs include Long Term Evolution, LTE, New Radio, NR, which may also be known as fifth generation, 5G, radio access technology and MulteFire.

For example in the context of LTE, wireless network node 120 may be referred to as eNB while wireless network node 120 may be referred to as gNB in the context of NR. In some example embodiments, wireless network node 120 may be referred to as a Transmission and Reception Point, TRP, or control multiple TRPs that may be co-located or non-co-located. In any case, example embodiments of the present disclosure are not restricted to any particular wireless technology. Instead, example embodiments may be exploited in any wireless communication system, wherein multi-panel uplink transmissions are used.

Example embodiments of the present disclosure may be related to, e.g., using multiple antenna arrangements for uplink transmissions for PUSCH, in both, single- and multi-TRP environment. For instance, example embodiments of the present disclosure may be applied when operating on Frequency Range 2, FR2, but may also be relevant in FR1. Alternatively, or in addition, example embodiments of the present disclosure may be applied in FR3 (7-20 GHz), possibly at least in 6G.

Wireless network node 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. Wireless network node 120 may be connected, directly or via at least one intermediate node, with core network 130 or with another core network.

In some example embodiments, the network scenario may comprise a relay node instead of, or in addition to, UE 110 and/or wireless network node 120. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of wireless network node 120, such as a gNB. Thus, in some example embodiments, the DU part of a relay may be referred to as wireless network node 120 and the DU may perform tasks of wireless network node 120;
2) Mobile Termination, MT, part which may facilitate functionalities of UE 110, i.e., a backhaul link which may be the communication link between a parent node (DU), such as a DU part of wireless network node 120, and the relay, such as an IAB node. In some example embodiments, the MT part may be referred to as UE 110 and perform tasks of UE 110.

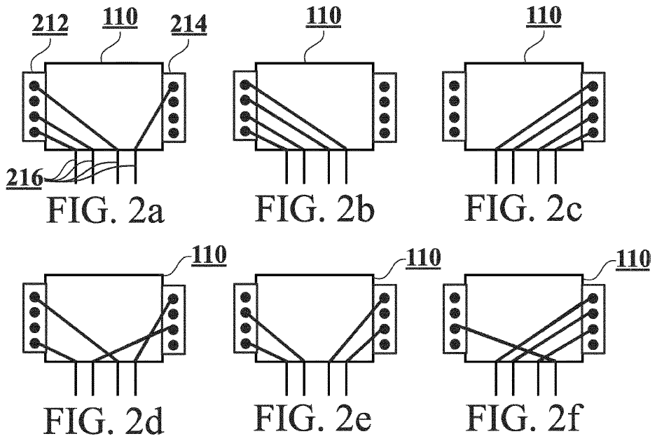

UE 110 may comprise multiple antenna arrangements for uplink transmissions. For example, UE 110 may be a Simultaneous Transmission Multi-Panel, STxMP, UE. That is, UE 110 may comprise at least two multiple antenna arrangements for uplink transmissions. UE 110 may thus have a flexible UE architecture. For example, UE 110 may have an architecture, wherein there are altogether four digital ports that may be shared in a flexible manner among the antenna arrangements of UE 110. Moreover, each antenna arrangement of UE 110 may support, e.g., up to four antenna ports as shown in the following FIGS. 2a-2f. FIGS. 2a-2f illustrate a scenario, wherein at maximum four antenna ports of UE 110 may be used for uplink transmission at a time. In some example embodiments, the antenna arrangements may be referred to as antenna panels.

FIG. 2a illustrates an example of a two-panel 4 port {3+1} transmission in accordance with at least some example embodiments. In FIG. 2a, first antenna arrangement of UE 110 is denoted by 212 and second antenna arrangement of UE 110 is denoted by 214. Each of first antenna arrangement 212 and second antenna arrangement 214 may comprise four uplink reference signal ports, such as SRS ports, as illustrated. In addition, digital antenna ports are denoted by 216.

FIG. 2a illustrates an example of a two-panel antenna arrangement with 4 port {3+1} transmission in accordance with at least some example embodiments. In FIG. 2a, 3 antenna ports are transmitted through the first antenna arrangement 212, and 1 antenna port is transmitted through the second antenna arrangement 214.

FIG. 2b illustrates an example of a two-panel antenna arrangement with 4 port {4+0} transmission in accordance with at least some example embodiments. In FIG. 2b, 4 antenna ports are transmitted through the first antenna arrangement 212, but nothing is transmitted through the second antenna arrangement 214.

FIG. 2c illustrates an example of a two-panel antenna arrangement with 4 port {0+4} transmission in accordance with at least some example embodiments. In FIG. 2c, 4 antenna ports are transmitted through the second antenna arrangement 214, but nothing is transmitted through the first antenna arrangement 212.

FIG. 2d illustrates an example of a two-panel antenna arrangement with 4 port {2+2} transmission in accordance with at least some example embodiments. In FIG. 2d, 2 antenna ports are transmitted through the first antenna arrangement 212, and 2 antenna ports are transmitted through the second antenna arrangement 214.

FIG. 2e illustrates an example of a two-panel antenna arrangement with 4 port {2+2} transmission in accordance with at least some example embodiments. In FIG. 2e, 2 antenna ports are transmitted through the first antenna arrangement 212, and 2 antenna ports are transmitted through the second antenna arrangement 214 with different configurations than in FIG. 2d.

FIG. 2f illustrates an example of a two-panel antenna arrangement with 4 port {1+3} transmission in accordance with at least some example embodiments. In FIG. 2f, 1 antenna port is transmitted through the first antenna arrangement 212, and 3 antenna ports are transmitted through the second antenna arrangement 214.

Embodiments of the present disclosure enable the use of flexible UE architectures illustrated in FIGS. 2a-2f. According to at least some example embodiments of the present disclosure, a number of uplink reference signal antenna ports may be different among uplink reference signal resources of the same uplink reference signal resource set. In some example embodiments, the uplink reference signal antenna ports may be referred to as SRS ports. The uplink reference signal resource may be referred to as an SRS resource and the uplink reference signal resource set may be referred to as an SRS resource set.

In some example embodiments, UE 110 may receive, from wireless network node 120, control information scheduling an uplink transmission. Said control information may comprise the following codepoint fields: a first uplink reference signal resource identifier associated with a first indicated uplink reference signal resource of a first resource set, and a second uplink reference signal resource identifier associated with a second indicated uplink reference signal resource of a second resource set. UE 110 may then derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource and determine a first uplink transmission parameter based on the first maximum rank value, and a second uplink transmission parameter based on the second maximum rank value. After that, UE 110 may perform the uplink transmission via a first antenna arrangement based at least in part on the first uplink transmission parameter, and via a second antenna arrangement based at least in part on the second uplink transmission parameter. It is noted that first and second uplink reference signal resources might not refer to a specific resource of the resource set, for instance the first or second resource of the resource set. It is also noted that first and second uplink reference signal resources neither do they refer to any precedence order or DCI encoding order or alike.

For example, the uplink transmission may be a codebook or non-codebook based PUSCH transmission and said control information may be Downlink Control Information, DCI. The maximum rank value for the PUSCH transmission occasion may be determined by UE 110 dynamically per DCI, based on the number of antenna ports, such as SRS antenna ports of the SRS resource. In some example embodiments, the number of SRS antenna ports of the SRS resource may be indicated by a SRS Resource Indicator, SRI, in the scheduling DCI. In some example embodiments, the maximum rank value may be referred to as a maximum number of layers for the uplink transmission, such as a PUSCH transmission.

In some example embodiments, the first and second uplink transmission parameters may be transmit precoder matrices. Alternatively, or in addition, the control information may further comprise a first Transmit Precoder Matrix Identifier, TPMI, associated with the first indicated uplink reference signal resource and a second TPMI associated with the second indicated uplink reference signal resource. That is, UE 110 may determine the TPMIs for the uplink transmission based on said control information. For example, UE 110 may determine the maximum number of layers for the PUSCH transmission occasion dynamically from the SRS resource indicated by the SRI in the scheduling DCI in order to determine also proper TPMI index. In some example embodiments, UE 110 may refer to the correct number of layers and TPMI value in table for precoding information and number of layers in 3GPP standard specification 38.212, where standard specification 38.211 provides actual complex valued precoder weights for indicated TPMI value and rank combination.

In some example embodiments, a resource element mapping of the antenna port(s) associated with uplink reference signals, such as SRS resource element mapping of antenna port(s) in both frequency and time domains may allow UE 110 to transmit up to four-port transmissions. The resource element mapping of antenna port(s) may allow UE 110 to transmit both, single- and multi-panel transmissions. That is, the resource elements associated with antenna ports may facilitate UE 110 to have shared digital ports across the multiple TX antenna panels of UE 110. In other words, the resource elements associated with antenna port(s) may allow UE 110 to transmit simultaneously via a single antenna arrangement or multiple antenna arrangements.

In some example embodiments, UE 110 may transmit, to wireless network node 120, first capability information of UE 110. Said first capability information may be indicative of a first maximum number of antenna ports supported by the first antenna arrangement of UE 110, of a second maximum number of antenna ports supported by the second antenna arrangement of UE 110, and of a total maximum number of antenna ports supported by UE 110. Said first capability information may hence comprise information about a maximum number of antenna ports for each of multiple antenna arrangements of UE 110. That is, UE 110 may provide a maximum number of antenna ports per its antenna arrangement. In addition, UE 110 may provide a total maximum number of its antenna ports.

In some example embodiments, the maximum number of antenna ports per antenna arrangement of UE 110 may be lower than or equal to the total maximum number of antenna ports of UE 110. For example, the first maximum number of antenna ports may be lower than or equal to the total maximum number of antenna ports, and the second maximum number of antenna ports may be lower than or equal to the total maximum number of antenna ports.

In some example embodiments, UE 110 may provide second capability information about supported two-panel combinations, e.g., {1+3, 2+2, 3+1} via capability signalling. In such a case, supported combinations of UE 110 may be {0+4, 1+3, 2+2, 3+1, 4+0}, or any subset thereof.

For example, UE 110 may transmit, to wireless network node 120, second capability information indicative of supported antenna port combinations across the first and second antenna arrangements. The supported antenna port combinations may individually comprise a first number of antenna ports for the first antenna arrangement lower than or equal to the first maximum number of antenna ports, and a second number of antenna ports for the second antenna arrangement lower than or equal to the second maximum number of antenna ports, and a sum of the first and second number of antenna ports is lower than or equal to the total maximum number of antenna ports.

In some example embodiments, one uplink reference signal resource set may be allocated per antenna arrangement of UE 110. For example, one SRS resource set may be allocated per antenna arrangement.

In some example embodiments, the first and second antenna arrangements may be associated with respective capability indexes.

Each antenna arrangement may be abstracted by UE 110 providing list of capability indices where each index refers to a specific antenna arrangement, for example, for {1+3} combination, maximumNumberOfSRSPortsForSharedArchitecture (index 0)=1, where index 0 refers to a first antenna arrangement of UE 110 with index 0, and maximumNumberOfSRSPortsSharedArchitecture (index 1)=3, where index 1 refers to a second antenna arrangement of UE 110 with index 1. In other words, list of different antenna arrangements may be provided to wireless network node 120 via capability signalling.

In some example embodiments, a number of antenna ports per uplink reference signal resource may be at maximum the same as the maximum number of antenna ports per antenna arrangement of UE 110. For example, an SRS resource may be up to per panel maximum number of antenna ports provided by the UE capability, i.e., as provided in said capability information.

In some example embodiments, the following rule may be applied for the time domain resource allocation. Uplink reference signal resources, such as SRS resources, of different resource sets may be triggered to be transmitted simultaneously when the total number of antenna ports to be used for uplink reference signal transmissions is less than or equal to the total maximum number of antenna ports supported by UE 110, possibly provided by the UE capability. That is, in such a case simultaneous uplink reference signal resources may be used. Alternatively, when the total number of antenna ports to be used for uplink reference signal transmissions is strictly greater than the total maximum number of antenna ports supported by UE 110, simultaneous transmission is disallowed and the uplink reference signal resources may be configured to be transmitted in Time Division Multiplexing, TDM, manner. In other words, the SRS resources may be configured to be transmitted simultaneously if the total number of the antenna ports of the simultaneous SRS resources is less than or equal to the total maximum number provided by the UE capability.

That is, UE 110 may receive, from wireless network node 120, configuration information indicative of a first resource set comprising first configured uplink reference signal resources, and of a second resource set comprising second configured uplink reference signal resources. The first configured uplink reference signal resources may individually comprise a first number of antenna ports lower than or equal to the first maximum number of antenna ports supported by the first antenna arrangement, and the second configured uplink reference signal resources may individually comprise a second number of antenna ports lower than or equal to the second maximum number of antenna ports supported by the second antenna arrangement.

A sum of a first number of antenna ports of a first configured uplink reference signal resource of the first resource set and of a second number of antenna ports of a second configured uplink reference signal resource of the second resource set may be strictly greater than the total maximum number of transmission layers or antenna ports supported by UE 110. In such a case, the first configured uplink reference signal resource of the first resource set may be time-multiplexed with the second configured uplink reference signal resource of the second resource set. That is, the first configured uplink reference signal resource of the first resource set may be restricted to be time-multiplexed with the second configured uplink reference signal resource of the second resource set.

In some example embodiments, the following selection may be applied for the at least one uplink transmission, such as a PUSCH transmission. Wireless network node 120 may transmit an indication to UE 110, the indication indicating a selection between a single- or multi-arrangement uplink transmission.

For example, wireless network node 120 may provide, possibly in a scheduling DCI, the selection of the single- or multi-panel transmission by a two-bit codepoint, e.g., as follows:
00: may indicate a single-panel transmission, wherein the maximum number of layers is the number of SRS ports in the SRS resource indicated by the SRI of the first SRS resource set;
01: may indicate a single-panel transmission, wherein the maximum number of layers is the number of SRS ports in the SRS resource indicated by the SRI of the second SRS resource set;
11: may indicate a two-panel transmission, e.g., towards a multi-TRP, wherein the maximum number of layers is the number of SRS ports in the SRS resource indicated by the SRI of the first SRS resource set for a first antenna arrangement of UE 110 and wherein the maximum number of layers is the number of SRS ports in the SRS resource indicated by the SRI of the second SRS resource set for a second antenna arrangement of UE 110.

In some example embodiments, the maximum number of layers per antenna arrangement of UE 110 may be dynamically determined based on the given SRI, i.e. based on the number of SRS antenna ports in the referred SRS resource.

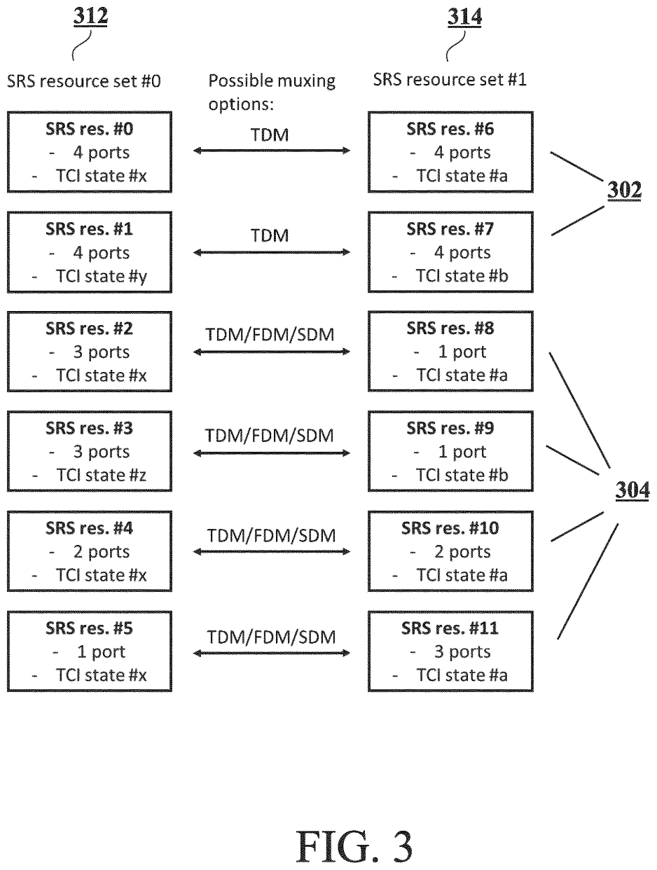

FIG. 3 illustrates an example of possible multiplexing options in accordance with at least some example embodiments. According to the example of FIG. 3, configuration of uplink reference signal resources may be performed as follows to support flexible digital port allocation among the antenna arrangement ports of UE 110.

Even though SRS is used as an example of an uplink reference signal in FIG. 3, the example may be applied for other similar reference signals as well. Similarly, even though PUSCH scheduling is used as an example below, the example may be applied for other uplink transmissions as well. In some example embodiments, UE 110 may determine the maximum number of layers per received scheduling grant and SRI(s). With reference to FIG. 2, in FIG. 3 first resource set (SRS resource set #0) for first antenna arrangement 212 of UE 110 is denoted by 312 and second resource set (SRS resource set #1) for second antenna arrangement 214 is denoted by 314.

According to the example of FIG. 3, the following configuration may be applied:
For PUSCH scheduling, upon reception of SRS resource set indicator codepoint 00 and SRI #1, UE 110 may assume TPMI over four antenna ports. That is, UE 110 may determine that the maximum number of layers is 4 for SRS resource set #0 and the maximum number of layers is 0 for SRS resource set #1. UE 110 may then transmit the PUSCH transmission using the maximum number of layers, i.e., 4 for first antenna arrangement 212. In such a case, the maximum number of layers for second antenna arrangement 214 may be determined as 0;
For PUSCH scheduling, upon reception of SRS resource set indicator codepoint 00 and SRI #4, UE 110 may assume TPMI over two antenna ports. That is, UE 110 may determine that the maximum number of layers is 2 for SRS resource set #0 and the maximum number of layers is 0 for SRS resource set #1. UE 110 may then transmit the PUSCH transmission using the maximum number of layers, i.e., 2 for first antenna arrangement 212. In such a case, the maximum number of layers for second antenna arrangement 214 may be determined as 0;
For PUSCH scheduling, upon reception of SRS resource set indicator codepoint 01 and SRI #5 there is no TPMI as PUSCH would be a single-port transmission. That is, UE 110 may determine that the maximum number of layers is 0 for SRS resource set #0 and the maximum number of layers is 1 for SRS resource set #1. UE 110 may then transmit the PUSCH transmission using the maximum number of layers, i.e., 1 for second antenna arrangement 214. In such a case, the maximum number of layers for first antenna arrangement 212 may be determined as 0;
For PUSCH scheduling, upon reception of SRS resource set indicator codepoint 11 and SRI #3 and SRI #9, UE 110 may assume TPMI over three antenna ports in the first panel and single port transmission in the second panel (transmit as SRS #9 was transmitted). That is, UE 110 may determine that the maximum number of layers is 3 for SRS resource set #0 and the maximum number of layers is 1 for SRS resource set #0. UE 110 may then transmit the PUSCH transmission using the maximum number of layers, i.e., 3 for first antenna arrangement 212 and 1 for second antenna arrangement 214.

For the top 2 cases 302 of FIG. 3, as the sum of the number of SRS ports of the first and second SRS resources exceeds the total maximum number of antenna ports supported by UE 110, then SDM/FDM is disallowed as multiplexing scheme, and only TDM may be used. In the bottom 4 cases 304, as the sum of the number of SRS ports of the first and second SRS resources does not exceed the total maximum number of antenna ports supported by UE 110, SDM/FDM/TDM are allowed as multiplexing scheme.

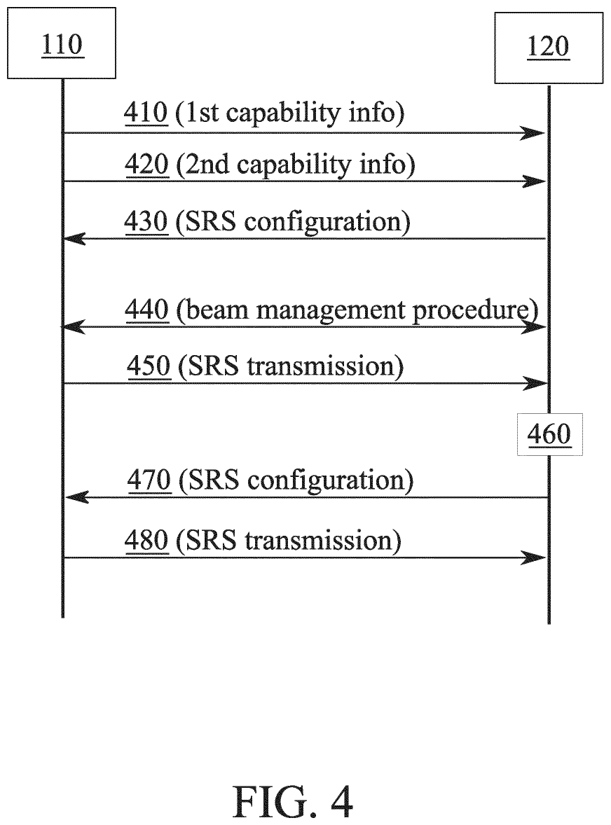

FIG. 4 illustrates a signaling graph in accordance with at least some example embodiments. On the vertical axes are disposed, from the left to the right, UE 110 and wireless network node 120. Time advances from the top towards the bottom.

At step 410, UE 110 may transmit, to wireless network node 120, first capability information indicative of a first maximum number of antenna ports supported by a first antenna arrangement of UE 110, of a second maximum number of antenna ports supported by a second antenna arrangement of UE 110, and of a total maximum number of antenna ports supported by UE 110. For example, UE 110 may perform reporting of supported maximum number of antenna ports per capability index+total number of antenna ports, possibly via Radio Resource Control, RRC, signalling. Said reporting may be semi-static.

In some example embodiments, the first maximum number of antenna ports may be lower than or equal to the total maximum number of antenna ports, and the second maximum number of antenna ports may be lower than or equal to the total maximum number of antenna ports.

At step 420, UE 110 may transmit second capability information to wireless network node 120. For example, UE 110 perform reporting of supported antenna ports combination. Said reporting may be semi-static. Said second capability information may be indicative of supported antenna port combinations across the first and second antenna arrangements. The supported antenna port combinations may individually comprise a first number of antenna ports for the first antenna arrangement lower than or equal to the first maximum number of antenna ports, and a second number of antenna ports for the second antenna arrangement lower than or equal to the second maximum number of antenna ports. A sum of the first and second number of antenna ports may be lower than or equal to the total maximum number of antenna ports.

At step 430, UE 110 may receive, from wireless network node 120, configuration information indicative of a first resource set comprising one or more first configured uplink reference signal resources, and of a second resource set comprising one or more second configured uplink reference signal resources. For example, UE 110 may receive an SRS configuration (1st and 2nd resource sets) and Quasi Co-Location, QCL, -typed association with respective CSI-RS/SSBs, possibly via RRC. Said configuration may be semi-static.

In some example embodiments, the first configured uplink reference signal resources individually may comprise a first number of antenna ports lower than or equal to the first maximum number of antenna ports supported by the first antenna arrangement of UE 110, and the second configured uplink reference signal resources individually may comprise a second number of antenna ports lower than or equal to the second maximum number of antenna ports supported by the second antenna arrangement of UE 110.

In some example embodiments, a sum of a first number of antenna ports of a first configured uplink reference signal resource of the first resource set and of a second number of antenna ports of a second configured uplink reference signal resource of the second resource set may be strictly greater than a total maximum number of antenna ports supported by UE 110.

In this case, the first configured uplink reference signal resource of the first resource set may be restricted to be time-multiplexed with the second configured uplink reference signal resource of the second resource set. Time-multiplexing restriction may only apply if the sum is strictly greater than the total maximum number of antenna ports.

In some example embodiments, a first configured uplink reference signal resource of the first resource set is spatial/frequency/time-multiplexed with a second configured uplink reference signal resource of the second resource set if the a sum of a first number of antenna ports of the first configured uplink reference signal resource and of a second number of antenna ports of the second configured uplink reference signal resource is lower than or equal to the total maximum number of antenna ports supported by UE 110.

In some example embodiments, the first and second configured uplink reference signal resources are Sounding Reference Signal, SRS, resources, and the first and second resource sets are SRS resource sets.

At step 440, beam management procedure may be performed. For example, a beam management procedure with CSI Report (N best CRI/SSB_Index along with capability indexes of the respective antenna arrangements are reported through PUCCH; semi-dynamic reporting) may be performed.

At step 450, UE 110 may perform SRS transmission, e.g. based on configured/indicated SRS resources.

At step 460, wireless network node 120 may perform CSI computation (SRI, RI, TPMI).

At step 470, UE 110 may receive, from wireless network node 120, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set. For example, wireless network node 120 may perform DCI scheduling a PUSCH (DCI format 0_x) comprising the indicated 1st and 2nd SRIs (SRI, RI, TPMI).

UE 110 may then derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource. UE 110 may further determine a first uplink transmission parameter based on the first maximum rank value, and a second uplink transmission parameter based on the second maximum rank value. In addition, UE 110 may perform the uplink transmission via a first antenna arrangement of the apparatus based at least in part on the first uplink transmission parameter, and via a second antenna arrangement of the apparatus based at least in part on the second uplink transmission parameter. Wireless network node 120 may perform said derivation and determination similarly, and then receive the uplink transmission accordingly.

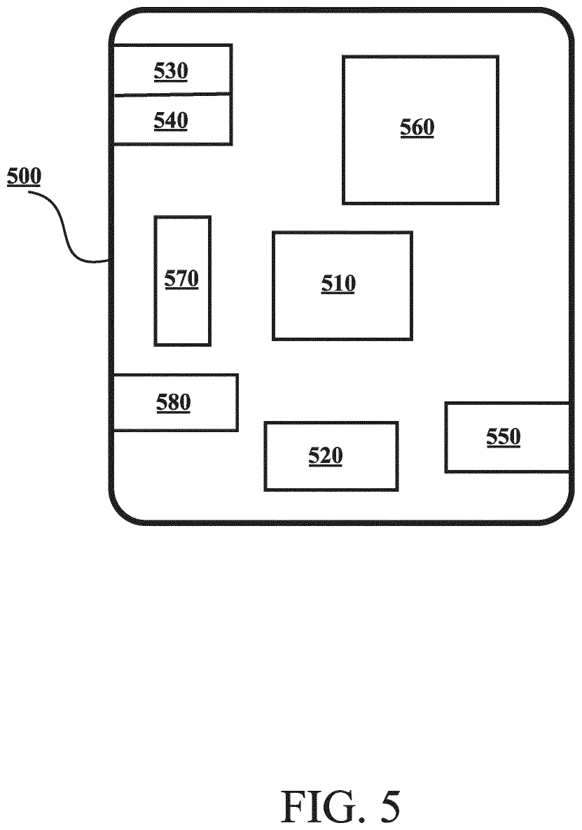

FIG. 5 illustrates an example apparatus capable of supporting at least some example embodiments. Illustrated is device 500, which may comprise, for example, UE 110 or wireless network node 120, or a control device configured to control the functioning thereof, possibly when installed therein. Comprised in device 500 is processor 510, which may comprise, for example, a single- or multi-core processor wherein a single-core processor comprises one processing core and a multi-core processor comprises more than one processing core. Processor 510 may comprise, in general, a control device. Processor 510 may comprise more than one processor. Processor 510 may be a control device. A processing core may comprise, for example, a Cortex-A8 processing core manufactured by ARM Holdings or a Steamroller processing core produced by Advanced Micro Devices Corporation. Processor 510 may comprise at least one Qualcomm Snapdragon and/or Intel Atom processor. Processor 510 may comprise at least one application-specific integrated circuit, ASIC. Processor 510 may comprise at least one field-programmable gate array, FPGA. Processor 510 may be means for performing method steps in device 500. Processor 510 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 500 may comprise memory 520. Memory 520 may comprise random-access memory and/or permanent memory. Memory 520 may comprise at least one RAM chip. Memory 520 may comprise solid-state, magnetic, optical and/or holographic memory, for example. Memory 520 may be at least in part accessible to processor 510. Memory 520 may be at least in part comprised in processor 510. Memory 520 may be means for storing information. Memory 520 may comprise computer instructions that processor 510 is configured to execute. When computer instructions configured to cause processor 510 to perform certain actions are stored in memory 520, and device 500 overall is configured to run under the direction of processor 510 using computer instructions from memory 520, processor 510 and/or its at least one processing core may be considered to be configured to perform said certain actions. Memory 520 may be at least in part comprised in processor 510. Memory 520 may be at least in part external to device 500 but accessible to device 500.

Device 500 may comprise a transmitter 530. Device 500 may comprise a receiver 540. Transmitter 530 and receiver 540 may be configured to transmit and receive, respectively, information in accordance with at least one cellular or non-cellular standard. Transmitter 530 may comprise more than one transmitter. Receiver 540 may comprise more than one receiver. Transmitter 530 and/or receiver 540 may be configured to operate in accordance with Global System for Mobile communication, GSM, Wideband Code Division Multiple Access, WCDMA, Long Term Evolution, LTE, and/or 5G/NR standards, for example.

Device 500 may comprise a Near-Field Communication, NFC, transceiver 550. NFC transceiver 550 may support at least one NFC technology, such as Bluetooth, Wibree or similar technologies.

Device 500 may comprise User Interface, UI, 560. UI 560 may comprise at least one of a display, a keyboard, a touchscreen, a vibrator arranged to signal to a user by causing device 500 to vibrate, a speaker and a microphone. A user may be able to operate device 500 via UI 560, for example to accept incoming telephone calls, to originate telephone calls or video calls, to browse the Internet, to manage digital files stored in memory 520 or on a cloud accessible via transmitter 530 and receiver 540, or via NFC transceiver 550, and/or to play games.

Device 500 may comprise or be arranged to accept a user identity module 570. User identity module 570 may comprise, for example, a Subscriber Identity Module, SIM, card installable in device 500. A user identity module 570 may comprise information identifying a subscription of a user of device 500. A user identity module 570 may comprise cryptographic information usable to verify the identity of a user of device 500 and/or to facilitate encryption of communicated information and billing of the user of device 500 for communication effected via device 500.

Processor 510 may be furnished with a transmitter arranged to output information from processor 510, via electrical leads internal to device 500, to other devices comprised in device 500. Such a transmitter may comprise a serial bus transmitter arranged to, for example, output information via at least one electrical lead to memory 520 for storage therein. Alternatively to a serial bus, the transmitter may comprise a parallel bus transmitter. Likewise processor 510 may comprise a receiver arranged to receive information in processor 510, via electrical leads internal to device 500, from other devices comprised in device 500. Such a receiver may comprise a serial bus receiver arranged to, for example, receive information via at least one electrical lead from receiver 540 for processing in processor 510. Alternatively to a serial bus, the receiver may comprise a parallel bus receiver.

Device 500 may comprise further devices not illustrated in FIG. 5. For example, where device 500 comprises a smartphone, it may comprise at least one digital camera. Some devices 500 may comprise a back-facing camera and a front-facing camera, wherein the back-facing camera may be intended for digital photography and the front-facing camera for video telephony. Device 500 may comprise a fingerprint sensor arranged to authenticate, at least in part, a user of device 500. In some example embodiments, device 500 lacks at least one device described above. For example, some devices 500 may lack a NFC transceiver 550 and/or user identity module 570.

Processor 510, memory 520, transmitter 530, receiver 540, NFC transceiver 550, UI 560 and/or user identity module 570 may be interconnected by electrical leads internal to device 500 in a multitude of different ways. For example, each of the aforementioned devices may be separately connected to a master bus internal to device 500, to allow for the devices to exchange information. However, as the skilled person will appreciate, this is only one example and depending on the example embodiment, various ways of interconnecting at least two of the aforementioned devices may be selected without departing from the scope of the example embodiments.

In some example embodiments, device 500 may comprise receiver 580, like a WUR. Transmitter 530 and receiver 540 may form a transceiver, like an NR transceiver, for communicating while receiver 580 may be for receiving, not for transmitting. The transceiver formed by transmitter 530 and receiver 540 may be referred to as first radio entity 210 and receiver 580 may be referred to as second radio entity 220.

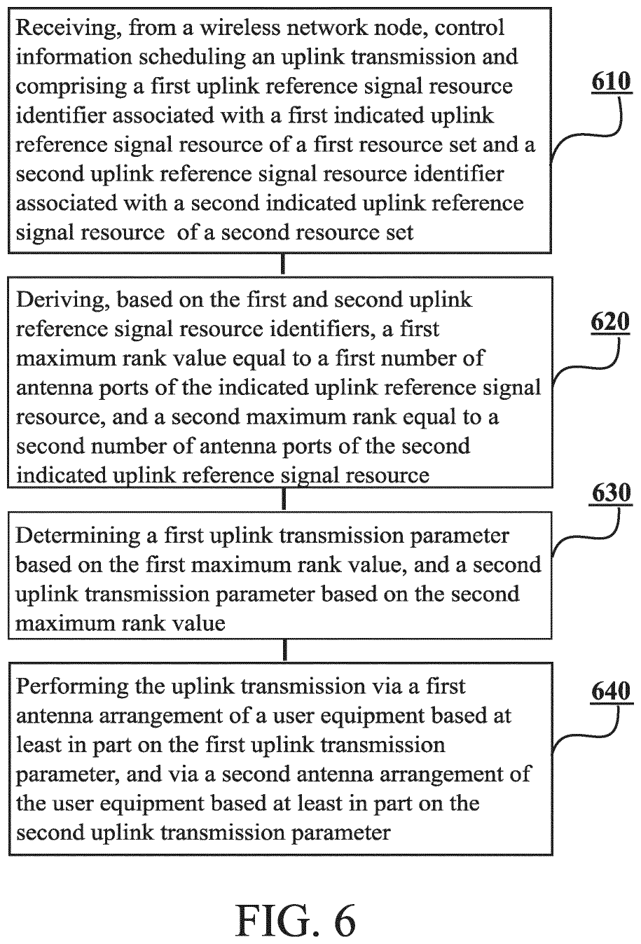

FIG. 6 is a flow graph of a method in accordance with at least some example embodiments. The steps of the method may be performed by UE 110 or by a control device configured to control the functioning thereof, possibly when installed therein.

The method may comprise, at step 610, receiving, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set. The method may further comprise, at step 620, deriving, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource. In addition, the method may comprise, at step 630, determining a first uplink transmission parameter based on the first maximum rank value, and a second uplink transmission parameter based on the second maximum rank value. Finally, the method may comprise, at step 640, performing the uplink transmission via a first antenna arrangement of a user equipment based at least in part on the first uplink transmission parameter, and via a second antenna arrangement of the user equipment based at least in part on the second uplink transmission parameter.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, such as, for example, UE 110 or wireless network node 120, may comprise means for carrying out the example embodiments described above and any combination thereof.

In an example embodiment, a computer program may be configured to cause a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, such as, for example, UE 110 or wireless network node 120, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the disclosure. One skilled in the relevant art will recognize, however, that the disclosure can be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks, for example in 3GPP networks.

### Acronyms List

3GPP 3rd Generation Partnership Project
BS Base Station
CSI Channel State Information
DCI Downlink Control Information
DU Distributed Unit
FR Frequency Range
GSM Global System for Mobile communication
IAB Integrated Access and Backhaul
IoT Internet of Things
LTE Long-Term Evolution
M2M Machine-to-Machine
MT Mobile Termination
NFC Near-Field Communication
NR New Radio
PUCCH Physical Uplink Control Channel
PUSCH Physical Uplink Shared Channel
QCL Quasi Co-Location
RAT Radio Access Technology
RRC Radio Resource Control
RI Rank Indicator
RS Reference Signal
SRI SRS Resource Indicator
SRS Sounding Reference Signal
SSB Synchronization Signal Block
STxMP Simultaneous Transmission Multi-Panel
TDM Time Division Multiplexing
TPMI Transmit Precoding Matrix Indicator
TRP Transmission and Reception Point
UE User Equipment
UI User Interface
WCDMA Wideband Code Division Multiple Access
WiMAX Worldwide Interoperability for Microwave Access
WLAN Wireless Local Area Network

### REFERENCE SIGNS LIST

| | |
|---|---|
| 110 | UE |
| 115, 125, 135 | Interfaces |
| 120 | Wireless network node |
| 130 | Core network |
| 212 | First antenna arrangement |
| 214 | Second antenna arrangement |
| 216 | Digital antenna ports |
| 302 | Top two cases in FIG. 3 |
| 304 | Bottom four cases in FIG. 3 |
| 312 | SRS resource for the first antenna arrangement |
| 314 | SRS resource for the second antenna arrangement |
| 410-470 | Steps in FIG. 4 |
| 500-580 | Structure of the apparatus of FIG. 5 |
| 610-640 | Phases of the method in FIG. 6 |

1-28. (canceled)

29. An apparatus comprising:
at least one processor; and
at least one memory storing instructions that, when executed by the at least one processor, cause the apparatus at least to:
receive, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set;
derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource;
determine a first uplink transmission parameter based on the first maximum rank value, and a second uplink transmission parameter based on the second maximum rank value; and
perform the uplink transmission via a first antenna arrangement of the apparatus based at least in part on the first uplink transmission parameter, and via a second antenna arrangement of the apparatus based at least in part on the second uplink transmission parameter.

30. The apparatus according to claim 29, wherein the first and second uplink transmission parameters are transmit precoder matrices.

31. The apparatus according to claim 29, wherein the control information further comprises a first Transmit Precoder Matrix Identifier (TMPI) associated with the first indicated uplink reference signal resource, and a second TPMI associated with the second indicated uplink reference signal resource.

32. The apparatus according to claim 29, wherein the stored instructions further cause, when executed by the at least one processor, the apparatus at least to:
transmit, to the wireless network node, first capability information indicative of a first maximum number of antenna ports supported by the first antenna arrangement, of a second maximum number of antenna ports supported by the second antenna arrangement, and of a total maximum number of antenna ports supported by the apparatus.

33. The apparatus according to claim 32, wherein the first maximum number of antenna ports is lower than or equal to the total maximum number of antenna ports, and the second maximum number of antenna ports is lower than or equal to the total maximum number of antenna ports.

34. The apparatus according to claim 32, wherein the stored instructions further cause, when executed by the at least one processor, the apparatus at least to:
transmit, to the wireless network node, second capability information indicative of supported antenna port combinations across the first and second antenna arrangements, wherein the supported antenna port combinations individually comprise a first number of antenna ports for the first antenna arrangement lower than or equal to the first maximum number of antenna ports, and a second number of antenna ports for the second antenna arrangement lower than or equal to the second maximum number of antenna ports, and a sum of the first and second number of antenna ports is lower than or equal to the total maximum number of antenna ports.

35. The apparatus according to claim 29, wherein the first and second antenna arrangements are associated with respective capability indexes.

36. The apparatus according to claim 29, wherein the stored instructions further cause, when executed by the at least one processor, the apparatus at least to:
receive, from the wireless network node, configuration information indicative of a first resource set comprising first configured uplink reference signal resources, and of a second resource set comprising second configured uplink reference signal resources.

37. The apparatus according to claim 36, wherein the first configured uplink reference signal resources individually comprise a first number of antenna ports lower than or equal to a first maximum number of antenna ports supported by the first antenna arrangement, and the second configured uplink reference signal resources individually comprise a second number of antenna ports lower than or equal to a second maximum number of antenna ports supported by the second antenna arrangement.

38. The apparatus according to claim 36, wherein a sum of a first number of antenna ports of a first configured uplink reference signal resource of the first resource set and of a second number of antenna ports of a second configured uplink reference signal resource of the second resource set is strictly greater than a total maximum number of antenna ports supported by the apparatus.

39. The apparatus according to claim 38, wherein the first configured uplink reference signal resource of the first resource set is restricted to be time-multiplexed with the second configured uplink reference signal resource of the second resource set.

40. The apparatus according to claim 36, wherein a first configured uplink reference signal resource of the first resource set is spatially-multiplexed or frequency-multiplexed or time-multiplexed with a second configured uplink reference signal resource of the second resource set if a sum of a first number of antenna ports of the first configured uplink reference signal resource and of a second number of antenna ports of the second configured uplink reference signal resource is lower than or equal to a total maximum number of antenna ports supported by the apparatus.

41. The apparatus according to claim 36, wherein the first and second configured uplink reference signal resources are Sounding Reference Signal, SRS, resources, and the first and second resource sets are SRS resource sets.

42. An apparatus comprising:
at least one processor; and
at least one memory storing instructions that, when executed by the at least one processor, cause the apparatus at least to:
transmit, to a user equipment, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set;
derive, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource;
determine a first uplink transmission parameter based on the first maximum rank value, and a second uplink transmission parameter based on the second maximum rank value; and
receive the uplink transmission via a first antenna arrangement of the user equipment based at least in part on the first uplink transmission parameter, and via a second antenna arrangement of the user equipment based at least in part on the second uplink transmission parameter.

43. The apparatus according to claim 42, wherein the first and second uplink transmission parameters are transmit precoder matrices.

44. The apparatus according to claim 42, wherein the control information further comprises a first Transmit Precoder Matrix Identifier (TMPI) associated with the first indicated uplink reference signal resource, and a second (TPMI) associated with the second indicated uplink reference signal resource.

45. The apparatus according to claim 42, wherein the stored instructions further cause, when executed by the at least one processor, the apparatus at least to:
receive, from the user equipment, first capability information indicative of a first maximum number of antenna ports supported by the first antenna arrangement, of a second maximum number of antenna ports supported by the second antenna arrangement, and of a total maximum number of antenna ports supported by the user equipment.

46. The apparatus according to claim 45, wherein the first maximum number of antenna ports is lower than or equal to the total maximum number of antenna ports, and the second maximum number of antenna ports is lower than or equal to the total maximum number of antenna ports.

47. The apparatus according to claim 45, wherein the stored instructions further cause, when executed by the at least one processor, the apparatus at least to:
receive, from the user equipment, second capability information indicative of supported antenna port combinations across the first and second antenna arrangements, wherein the supported antenna port combinations individually comprise a first number of antenna ports for the first antenna arrangement lower than or equal to the first maximum number of antenna ports, and a second number of antenna ports for the second antenna arrangement lower than or equal to the second maximum number of antenna ports, and a sum of the first and second number of antenna ports is lower than or equal to the total maximum number of antenna ports.

48. A method comprising, by the user equipment:
receiving, from a wireless network node, control information scheduling an uplink transmission and comprising a first uplink reference signal resource identifier associated with a first indicated uplink reference signal resource of a first resource set, and a second uplink reference signal resource identifier associated with a second indicated uplink reference signal resource of a second resource set;
deriving, based on the first and second uplink reference signal resource identifiers, a first maximum rank value equal to a first number of antenna ports of the first indicated uplink reference signal resource, and a second maximum rank value equal to a second number of antenna ports of the second indicated uplink reference signal resource;
determining a first uplink transmission parameter based on the first maximum rank value, and a second uplink transmission parameter based on the second maximum rank value; and
performing by the user equipment the uplink transmission via a first antenna arrangement of the user equipment based at least in part on the first uplink transmission parameter, and via a second antenna arrangement of the user equipment based at least in part on the second uplink transmission parameter.
